(19) United States
(12) Patent Application Publication
(10) Pub. No.: US 2023/0124840 A1
(43) Pub. Date: Apr. 20, 2023

(54) Systems, Methods, And Apparatuses For Generating And Updating Manifests For Content

(71) Applicant: Comcast Cable Communications, LLC, Philadelphia, PA (US)

(72) Inventors: Alexander Giladi, Denver, CO (US); Christopher Lintz, Denver, CO (US)

(21) Appl. No.: 17/955,842

(22) Filed: Sep. 29, 2022

Related U.S. Application Data
(60) Provisional application No. 63/256,197, filed on Oct. 15, 2021.

(51) Int. Cl. G11B 27/10; G11B 27/34; H04N 21/235

(52) U.S. Cl. CPC G11B 27/102; G11B 27/34; H04N 21/235

(57) ABSTRACT

Methods, systems, and apparatuses for generating and updating manifests for content are described herein. An initial manifest for content may be sent to a media device. The initial manifest may facilitate the media device outputting a first plurality of segments of the content. A second plurality of segments of the content may become available for output at a later time. A current manifest may be sent to the media device. As another example, at least one manifest portion associated with the initial manifest may be sent to the media device. The current manifest and the at least one manifest portion may facilitate the media device outputting the second plurality of segments.

### CROSS-REFERENCE TO RELATED PATENT APPLICATION

This application claims priority to U.S. Provisional Application No. 63/256,197, filed on Oct. 15, 2021, the entirety of which is incorporated by reference herein.

### BACKGROUND

Uninterrupted delivery of content is crucial for an overall positive user experience. Generating and serving manifests for content on a per-user basis requires an extensive amount of computational resources. When computational resources are stretched too thin, cascading effects within these systems may negatively impact the user experience. These and other considerations are discussed herein.

### SUMMARY

It is to be understood that both the following general description and the following detailed description are exemplary and explanatory only and are not restrictive. Methods, systems, and apparatuses for generating and updating manifests for content are described herein. Manifests for some types of content, such as linear/live content, may be updated as new segments for the content are prepared for delivery (e.g., as new segments of the content are encoded, packaged, etc.).

As an example, an “initial” manifest for content may be sent to a device for playback at a first time when a first group of segments of the content are available for delivery/output. A “current” manifest may be sent to the device—or generated by the device—at a later time when additional segments of the content are available for delivery/output. The current manifest may be generated based on the initial manifest and one or more additional manifest portions corresponding to the additional segments of the content. That is, the one or more additional manifest portions may be used to update the initial manifest in order to facilitate access to the additional segments of the content.

Other examples are possible as well. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIG. 2 shows example data elements;

FIG. 3A shows an example workflow;

FIG. 3B shows an example workflow;

FIG. 4A shows an example workflow;

FIG. 4B shows an example workflow;

FIG. 5A shows an example data structure;

FIG. 5B shows an example data structure;

FIG. 5C shows an example data structure;

FIG. 5D shows an example data structure;

FIG. 6 shows an example system;

FIG. 7 shows a flowchart for an example method;

FIG. 8 shows a flowchart for an example method;

FIG. 9 shows a flowchart for an example method;

FIG. 10 shows a flowchart for an example method; and

FIG. 11 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Methods, systems, and apparatuses for generating and updating manifests for content are described herein. Manifests for content, such as content that is being simultaneously recorded and played, may increase in size as new segments of content are encoded, packaged, etc., and prepared for delivery. A manifest that is generated for content that has just begun may have a much smaller size, relatively speaking, compared to a manifest for the same content after it has aired for an hour. The latter manifest would be larger because it must account for all of the segments of the content from the time the content began to air to the time the latter manifest was generated. As manifests increase in size, the demand for processing resources to generate those manifests and the demand for network bandwidth to deliver the manifests and corresponding content segments increase as well.

The increased demand for processing resources and network bandwidth may be alleviated by “patching” (e.g., updating, adding to, modifying, etc.) an initial manifest, rather than sending an entirely new manifest when new segments become available. An initial manifest may be generated when content is first requested/recorded, and the initial manifest may be “patched” with additional manifest portions corresponding to new content segments as needed. For example, an initial manifest associated with content may be sent to a client device at a first time when the content is initially requested (e.g., for output, recording, or both) and when a first plurality of segments are available for delivery/output. A current manifest associated with the content may be sent at a later time—or generated by the client device—when additional segments of the content become available for delivery/output. The current manifest may be generated by updating the initial manifest using additional manifest portions corresponding to the additional segments of the content (e.g., by “patching” the initial manifest). The current manifest may be generated on a “just in time” basis by an upstream device(s). For example, the current manifest associated with the content may be generated on-the-fly as the additional segments become available (e.g., prior to those segments being requested).

The initial manifest may be sent to a device that is concurrently outputting and recording the content (e.g., “hot-recording” the content) during a recording session. The device may receive the initial manifest in response to a first request, such as a manifest request that may be sent by the device when the recording session begins. The device may receive the initial manifest and subsequently request the first plurality of segments using the initial manifest. At a later time during the recording session, the device may send a second request. For example, the second request may be a second manifest request that the device may send to facilitate access to a second plurality of segments (e.g., additional segments that follow the first plurality segments). The current manifest may be generated based on the second request, or the current manifest may have been previously generated, in which case the current manifest may simply be sent directly in response to the second request. The current manifest may be sent to the device in response to the second request. Alternatively, the additional manifest portions corresponding to the second plurality of segments may be sent to the device, and the device may use the additional manifest portions to generate the current manifest. The device may request the additional portion(s) of the content using the current manifest.

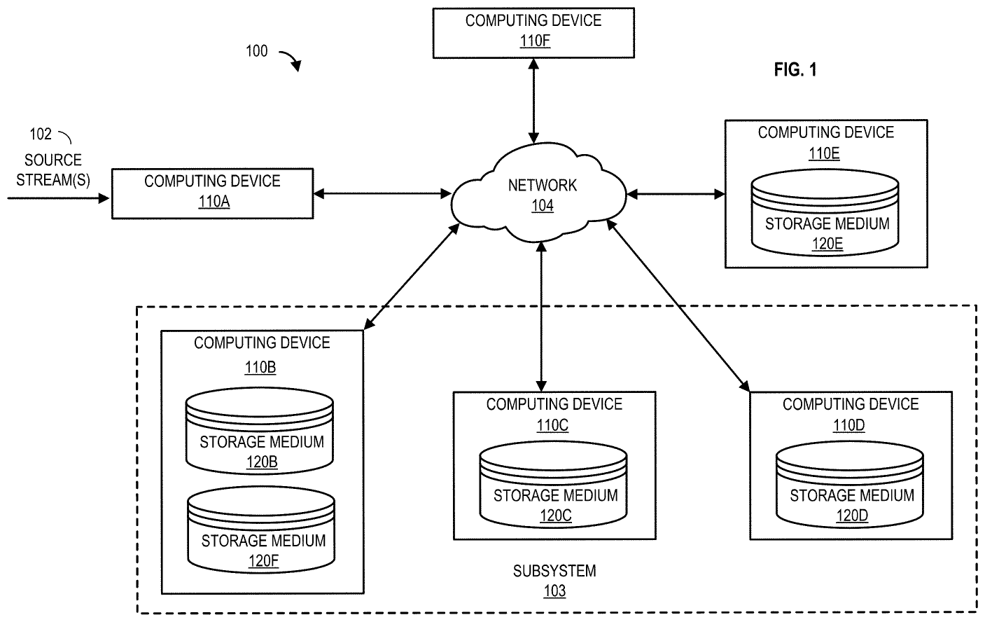

FIG. 1 shows an example system 100. The system 100 may comprise a content delivery network, a data network, a content distribution network, or any other network or content distribution system. The system 100 may comprise computing devices 110A-110F. Any of the computing devices 110A, 110B, 110C, 110D, 110E, and/or 110F shown in the system 100 may comprise any number of components/modules, storage media, etc., in addition to (or less than) the components/modules, storage media, etc., that are shown in FIG. 1. For example, as shown in FIG. 1, the computing devices 110B-110E each comprise one or more storage media. In other configurations of the system 100, those storage media may be separate devices (e.g., data servers) or they may be part of another computing device shown in the system 100.

The computing devices 110A-110F may communicate via a network 104. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 104 via a variety of transmission paths, including wireless paths (e.g., satellite paths, Wi-Fi paths, cellular paths, etc.) and terrestrial paths (e.g., wired paths, a direct feed source via a direct line, etc.).

The system 100 may comprise a subsystem 103. The subsystem 103 may comprise an upstream portion/tier (e.g., an origin) of a content delivery network, a data network, a content distribution network, or any other network or content distribution system. As shown in FIG. 1, the computing devices 110B-110D may be part of the subsystem 103; however, it is to be understood that the subsystem 103 may comprise greater or fewer devices than the computing devices 110B-110D. The subsystem 103 may generate and/or output portions of content for consumption (e.g., output). For example, the subsystem 103 may convert raw versions of content (e.g., broadcast content) into compressed or otherwise more “consumable” versions suitable for playback/output by client devices, user devices, media devices, and other consumer-level computing devices. “Consumable” versions of content—or portions thereof—generated and/or output by the subsystem 103 may include, for example, data files adhering to ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC), MPEG EVC, MPEG LC-EVC, AOM AV1, VP9, or any other video file format, whether such format is presently known or developed in the future. The computing device 110B-110D shown as being part of the subsystem 103 in FIG. 1 may operate as a system to generate and/or output portions of content, convert raw versions of content (e.g., broadcast content) into compressed or otherwise more “consumable” versions, etc.

The computing device 110B may comprise a cloud digital video recorder, an ingest handler, a segment handler, and/or any other suitable device(s)/module(s) for receiving content segments and metadata. The computing device 110B may comprise a storage medium 120B for storing content segments and a storage medium 120F for storing content metadata and/or recording session metadata. Content segments may be generated by the computing device 110A for each recording session of a plurality of recording sessions, and the computing device 110B may store segments received from the computing device 110A in the storage medium 120B and corresponding content metadata for those segments in the storage medium 120F. For example, the content metadata may be stored in a session index in the storage medium 120F. The session index may comprise the recording session metadata, such as recording session identifiers associated with the plurality of recording sessions (e.g., devices recording content), device identifiers, content identifiers, etc. The content metadata stored in the storage medium 120F may comprise segment metadata, such as a Presentation Time Stamp (PTS), Period, other metadata associated with each segment (e.g., content identifier(s)).

The computing device 110C may comprise a manifest generator, a manifest updater, and/or any other suitable device(s)/module(s) for generating and updating manifests for content (and/or portions thereof). The computing device 110C may comprise a storage medium 120C for storing manifests for content (or portions thereof) associated with recording sessions (e.g., devices recording content) and a manifest index identifying the recording sessions, etc. The manifest index in the storage medium 120C may include metadata for each recording session. The metadata for each recording session may indicate/identify an initial manifest for requested content, including a time the initial manifest was published/generated (e.g., the MPD@id and MPD@publishTime attributes as defined in ISO/IEC 23009-1). The metadata for each recording session may also indicate/identify additional portions of the manifest associated with the content that are used to update the initial manifest, including a publish/generation time for each portion. Other metadata for each recording session may be indicated/identified as well.

The computing device 110D may comprise a server (e.g., a content server) and/or any other suitable device(s)/module(s) for processing requests for content, manifests for content, and/or segments of content. The computing device 110D may comprise a storage medium 120D for storing manifests for content (or portions thereof) that are not associated with a recording session (e.g., manifests for video on demand content and other “cold” manifest storage).

The computing device 110A may comprise an encoder, a transcoder, and/or any other device(s)/module(s) suitable for receiving raw forms of content and generating consumable content. The computing device 110A may receive a source stream 102 and transcode the source stream 102 to generate one or more transcoded streams, encoded streams, etc. (referred to herein collectively as “transcoded streams”). The source stream 102 may be a live stream (e.g., a linear content stream) or a previously recorded stream, or a video-on-demand (VOD) stream. The computing device 110A may receive the source stream 102 from an external source (e.g., a stream capture source, a data storage device, a media server, etc.). The computing device 110A may receive the source stream 102 via a wired or wireless network connection, such as the network 104 or another network (not shown). It should be noted that although a single source stream 102 is shown in FIG. 1, this is not to be considered limiting. The computing device 110A may receive any number of source streams 102. The computing device 110A may send the transcoded streams to the subsystem 103 using an ingest protocol, such as an HTTP-based DASH-IF Live Ingest protocol.

The computing device 110F may be in communication with each device shown in the system 100. The computing device 110F may comprise a client device, such as a content/media player, a set-top box, a smart device, a mobile device, a user device, etc. The computing device 110F may record content and/or output content. While FIG. 1 only shows one computing device 110F, it is to be understood that the system 100 may comprise any number of computing devices that record and/or output content items (or portions thereof). A manifest may be generated for each computing device (e.g., each client/playback device) that requests a manifest for a particular content item (or portion thereof), even if two or more computing devices specify the same manifest type and content segmentation type. For example, each manifest (or portion) may be specific to each computing device (e.g., each client/playback device).

The transcoded streams may correspond to a plurality of adaptive bitrate (ABR) representations of the source stream 102. For example, the transcoded streams may differ from each other with respect to audio bitrate, a number of audio channels, an audio CODEC, a video bitrate, a video frame size, a video CODEC, a combination thereof, and/or the like. The one or more transcoded streams may be sent to the computing device 110E (e.g., a just-in-time packager), as further described herein. For example, the source stream 102 (e.g., a mezzanine feed) may be used to generate one or more representations of a content item that have varying bitrates and/or alternative CODECs on-the-fly.

The subsystem 103 may support multiple content segmentation types. The computing device 110B may generate segments for each of the content segmentation types supported by the subsystem 103. Segments may alternately be referred to as “chunks.” The subsystem 103 may support both multiplexed segments (video and audio data included in a single multiplexed stream) and non-multiplexed segments (video and audio data included in separate non-multiplexed streams). Further, in the case of MPEG-DASH and/or HLS, the subsystem 103 may support container formats in compliance with international standards organization base media file format (ISO-BMFF, as defined in ISO/IEC 14496-12), motion picture experts group 2 transport stream (MPEG-2 TS, as defined in ISO/IEC 13818-1), extensible binary markup language (EBML), WebM, Matroska, or any combination thereof. The computing device 110B may store the segments in the storage medium 120B and corresponding content metadata in the storage medium 120F.

The computing device 110C may generate one or more manifests (e.g., manifest files) based on the segments stored in the storage medium 120B and corresponding content metadata stored in the storage medium 120F. In the case of MPEG-DASH and/or HLS, the manifest may be a MPEG-DASH media presentation description (MPD) file. The computing device 110C may generate one or more manifests based on a manifest type and/or a content segmentation type. For example, the computing device 110C may generate manifests that are number-based, list-based, time-based, etc. The manifests may facilitate the computing device 110F (e.g., a client/user device) accessing the corresponding segments of the content at one or more ABR representations.

The manifests may identify one or more segments of one or more ABR representations of the transcoded streams. For example, the transcoded streams may include three ABR representations of the source stream 102: a first representation with a bit rate of 2 megabits per second (Mbps) and a frame size of 720 p, a second representation with a bit rate of 750 kilobits per second (Kbps) and a frame size of 160 p, and a third representation with a bit rate of 250 kbps and a frame size of 120 p. More, fewer, and/or different ABR representations may be generated, where each generated ABR representation may have a plurality of segments.

The system 100 may comprise a computing device 110E. The computing device 110E may comprise a packaging device, such as a just-in-time packager. The computing device 110E may be in communication with each device shown in the system 100. The computing device 110F may communicate with the computing device 110E when requesting and/or receiving content and/or manifests (or portions thereof). The computing device 110E may comprise a storage medium 120E for storing metadata associated with manifests that are requested by and/or sent to the computing device 110F. As further discussed herein, the computing device 110E may receive a manifest for a particular content item (or portion thereof) from the subsystem 103. The computing device 110E may receive requests for segments (e.g., portions) of the content item from the computing device 110F according to the manifest. The computing device 110E may retrieve segments of the content from the subsystem 103, prepare/package the segments for output by the computing device 110F, and deliver the requested segments to the computing device 110F.

As an example, the computing device 110F may initiate a recording session to record content and send a request for an initial manifest (e.g., an HTTP GET request) associated with the content to the computing device 110E. The phrase “initial manifest” as used herein refers to a first manifest for the content that the computing device 110F may request and/or a first instance in which the computing device 110F requests a manifest associated with the content. The recording session may be associated with a recording session identifier. The computing device 110E may receive the request for the initial manifest and forward the request to the subsystem 103. For example, the computing device 110E may forward the request for the initial manifest to the computing device 110D. The computing device 110D may retrieve recording session data associated with recording session identifier via the computing device 110B and the storage medium 120F. The computing device 110D may determine whether the computing device 110F is concurrently outputting and recording the content (e.g., a “hot” recording session) or simply recording the content (e.g., a “cold” recording session). If computing device 110F is only recording the content, the computing device 110D may retrieve the initial manifest from the storage medium 120D (e.g., manifests for video on demand content and other “cold” manifest storage). However, if the computing device 110F is concurrently outputting and recording the content, the computing device 110D may request the initial manifest from the computing device 110C. For example, the computing device 110D may request the initial manifest from the computing device 110C by sending a URL identifying the recording session.

The computing device 110C may receive the request for the initial manifest from the computing device 110D. The computing device 110C may determine whether the manifest index in the storage medium 120C (e.g., identifying the recording sessions) includes an index (or entry) associated with the recording session. When the manifest index in the storage medium 120C does not include an index (or entry) associated with the recording session, the computing device 110C may retrieve corresponding content metadata from the session index stored in the storage medium 120F, create the index (or entry), and cache/store the index associated with the recording session in the manifest index in the storage medium 120C. The computing device 110C may generate the initial manifest based on the content metadata stored in the session index in the storage medium 120F. The computing device 110C may send the initial manifest to the computing device 110F (e.g., via the computing device 110B and/or the computing device 110E).

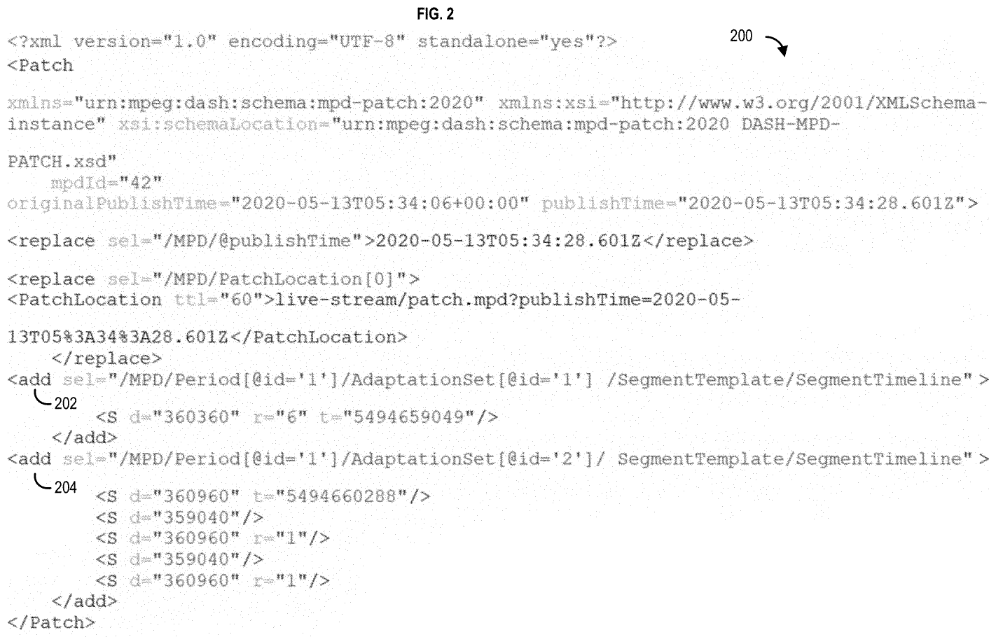

The initial manifest associated with the content may be sent to the computing device 110F at a first time when one or more segments are available for delivery/output and the content is initially requested (e.g., for output, recording, or both). A current manifest associated with the content may be sent to the computing device 110F at a later time when additional segments of the content are available for delivery/output. As further described herein, the current manifest may be generated by updating the initial manifest using additional manifest portions corresponding to the additional segments of the content. An example manifest portion 200 (e.g., a manifest “patch” defined in ISO/IEC 23009-1) is shown in FIG. 2. The manifest portion 200 may comprise, for example, a DASH MPD Patch file. The initial manifest may be updated—thereby generating the current manifest—using manifest portions such as the example manifest portion 200. The manifest portion 200 may comprise a plurality of manifest elements (XML elements), such as elements 202 and 204. The manifest elements 202 and 204 may identify the additional segments of the content that may be requested using the current manifest.

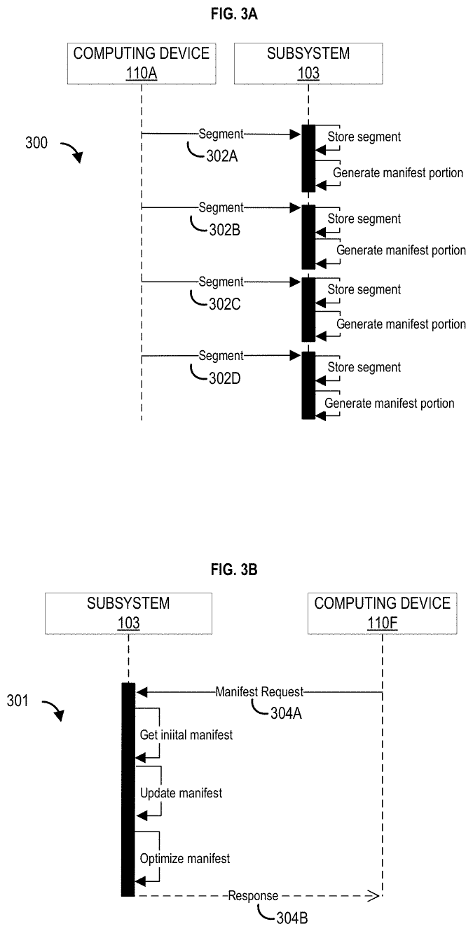

Turning now to FIGS. 3A and 3B, a workflow 300 and a workflow 301 are shown. As described herein, the initial manifest associated with the content may be sent to the computing device 110F when the recording session is begun. Alternatively, the initial manifest may be generated as the source stream 102 associated with the content is received and/or when a new period associated with the content is begun. The initial manifest may comprises a partial/skeleton manifest associated with the content. For example, the initial manifest may comprise information such as a Media Presentation Document associated with the content, a Period element(s), an AdaptationSet element(s), a Representation element(s), a SegmentTemplate element(s), and/or a ContentProtection element(s). As shown in FIG. 3A, the subsystem 103 (e.g., any of the computing devices 110B-110D) may receive a plurality of segments 302A-302D from the computing device 110A as they are received and prepared for output/delivery (e.g., as they are transcoded based on the source stream 102). For example, the subsystem 103 may receive the plurality of segments 302A-302D of content from the computing device 110A. Based on the plurality of segments 302A-302D, the subsystem 103 may determine a plurality of manifest portions associated with the content (e.g., such as the additional manifest portions described herein). For example, the subsystem 103 may store each segment of the plurality of segments 302A-302D that is received, and the subsystem 103 may determine (e.g., generate) a corresponding manifest portion for each segment. Each manifest portion of the plurality of manifest portions may comprise at least one of: an indication of a presentation start time for the corresponding segment; a timestamp for the corresponding segment; a period identifier for the corresponding segment; a duration for the corresponding segment; or a segment identifier for the corresponding segment.

The subsystem 103 may determine an additional manifest portion(s) (e.g., an update to the initial manifest) based on updates to the content other than new/additional segments. For example, the subsystem 103 may receive in indication (e.g., via an out-of-band application programming interface) of an event update associated with the content, and the subsystem 103 may determine an additional manifest portion(s) (e.g., an update to the initial manifest) based on the event update. The event update may comprise at least one of: an event scheduling notification interface update or an event scheduling and management update. An update to the content may comprise a digital rights management (DRM) update. For example, the subsystem 103 may determine an additional manifest portion(s) based on an indication of a DRM key rotation associated with the content (e.g., to update to the initial manifest with the new/updated DRM key(s)).

As shown in FIG. 3B, the computing device 110F may send a request 304A for the current manifest described herein. The request 304A for the current manifest may comprise a request to update the initial manifest (e.g., thereby resulting in the current manifest). While FIG. 3A shows the computing device 110F as the device that sends the request 304A, it is to be understood that any device in communication with the computing device 110F and the subsystem 103 may send the request 304A. The example shown in FIG. 3A and described herein (e.g., with the computing device 110F sending the request 304A) is meant to be exemplary and not limiting. The subsystem 103 may be configured to ignore the request 304A (e.g., cause the request 304A not to be processed) in certain scenarios. For example, the request 304A may not be processed if it comprises or indicates an identifier for a segment of the content that falls outside of a time-shift buffer for linear content. The time-shift buffer may comprise a duration of time (e.g., a quantity of seconds, minutes, or a portion(s) thereof). The time-shift buffer may be signaled/indicated in a DASH MPD, manifest, message, etc. Additionally, the request 304A may not be processed if it comprises or indicates a period of the content without any corresponding segments.

The subsystem 103 may apply (e.g., patch) the initial manifest associated with the content using the plurality of manifest portions as further described herein, thereby generating the current manifest. At 304B, the subsystem 103 may send the current manifest to the computing device 110F. In some examples, prior to sending the current manifest to the computing device 110F, the subsystem 103 may optimize the current manifest and corresponding metadata stored at the storage medium 120B and/or the storage medium 120F. For example, any segment identified in the current manifest that falls outside of the time-shift buffer may be removed from the current manifest and/or from the storage medium 120B. As another example, any segment identified in the current manifest associated with a presentation time that falls outside of the time-shift buffer associated with the content may be removed from the current manifest and/or from the storage medium 120B. As a further example, any segment identified in the current manifest associated with an event comprising an end time that falls outside of the time-shift buffer may be removed from the current manifest and/or from the storage medium 120B. The end time that falls outside of the time-shift buffer may be determined based on an event scheduling notification interface update or an event scheduling and management update as described herein.

As another example, the subsystem 103 may optimize the current manifest. The current manifest (or any manifest associated with the content) may comprise a plurality of manifest elements. The plurality of manifest elements may identify segments of the content, define one or more parameters of the content, etc. The plurality of manifest elements may comprise, for example, elements defined in the MPEG DASH specification. The plurality of manifest elements may comprise a first manifest element that indicates a timeline for segments of the content (e.g., a DASH SegmentTimeline element). For example, the timeline for the segments may indicate when each segment is available/indicated for playback. The timeline for the segments may use a run-length type of coding. The first manifest element may identify each segment using a segment element “S@r”. The duration may be identified/indicated in the current manifest by a duration element “S@d” for each segment. The subsystem 103 may optimize the current manifest (or any manifest associated with the content) by joining one or more of the segment elements and thereby reduce an overall size of the current manifest.

For example, the subsystem 103 may determine, for each two segment elements identified by the first manifest element (e.g., the DASH SegmentTimeline element), whether their respective duration elements (S@d values) match (e.g., determine whether consecutively identified segments have a same duration). In such a case, a value (S@r value) for of the first of the two segment elements may be incremented, and the second of the two segment elements may be removed. This example optimization process may be iterative. For example, the subsystem 103 may repeat this process for every two segment elements (e.g., consecutive segment elements) identified by the first manifest element until the respective duration elements (S@d values) do not match (e.g., until one of the two particular segment elements being evaluated has a different S@d value compared to the other segment element). As another example, the subsystem 103 may optimize the current manifest by associating one or more segment elements (e.g., SegmentTimeline elements) in the current manifest with another manifest element of the plurality of manifest elements, such as a manifest element corresponding to an AdaptationSet level of the current manifest. As a further example, the subsystem 103 may optimize the current manifest by identifying segment gaps in each representation of the content identified in the current manifest (e.g., missing segments) and associating such gaps with a further manifest element (e.g., a FailoverContent element(s)). The optimized current manifest may be stored in storage medium 120C.

In some scenarios, depending on compatibility and capability, the computing device 110F may generate the current manifest itself rather than receiving the current manifest from the subsystem 103. In such scenarios, the response at 304B may comprise any manifest portion(s) that may be required to generate the current manifest by the computing device 110F. For example, as described herein, the subsystem 103 may receive a first request for an initial manifest associated with content from the computing device 110F. The phrase “initial manifest” as used herein refers to a first manifest for the content that the computing device 110F may request and/or a first instance in which the computing device 110F requests a manifest associated with the content. The first request may be associated with the recording session in which the computing device 110F is concurrently outputting and recording the content. The subsystem 103 may determine the initial manifest and a manifest index associated with the recording session. For example, the subsystem 103 may determine the initial manifest and the manifest index based on the request for the initial manifest. The manifest index may comprise the content metadata stored in the session index stored in the storage medium 120F described herein. For example, the manifest index may comprise metadata for the recording session and a time the initial manifest was published/generated (e.g., a PublishTime element/identifier) as well as a time(s) additional portions of the manifest associated with the content that are used to update the initial manifest were generated (e.g., a PublishTime element/identifier for each portion).

The subsystem 103 may send the initial manifest to the computing device 110F as described herein. The subsystem 103 may receive a second request from the computing device 110F. The second request may comprise a request for at least one manifest portion of a plurality of manifest portions corresponding to new/additional segments of the content. The second request may be associated with the recording session, and the plurality of manifest portions may be identified in the manifest index. For example, the plurality of manifest portions may be associated with a second plurality of segments of the content. The subsystem 103 may retrieve corresponding segment metadata, such as a Presentation Time Stamp (PTS), Period, and/or other metadata associated with the second plurality of segments from the storage medium 120F.

The subsystem 103 may determine the at least one manifest portion based on the second request, the manifest index, and the corresponding segment metadata. For example, the initial manifest may comprise a first timestamp indicative of a time that the initial manifest was generated/published (e.g., a PublishTime element/identifier). The second request may comprise an indication of a request for an additional/current manifest portion associated with a time that is greater than the first timestamp (referred to herein as a “request time”). Based on the request time, the subsystem 103 may determine/retrieve the metadata associated with the second plurality of segments from the storage medium 120F. The subsystem 103 may determine (e.g., generate or identify) the at least one manifest portion based on the request time and the metadata associated with the second plurality of segments (e.g., to determine which segment(s) were or were not included in the initial manifest). The subsystem 103 may send the at least one manifest portion to the computing device 110F. The at least one manifest portion may be configured to facilitate access to at least one segment of the second plurality of segments of the content. For example, the computing device 110F may use the at least one manifest portion to update the initial manifest, thereby generating a current manifest as described herein.

The subsystem 103 may store an indication of the at least one manifest portion in the manifest index (e.g., to indicate the computing device 110F has received the at least one manifest portion). The computing device 110F may request further manifest portions during the recording session. The subsystem 103 may store an indication in the manifest index of each further manifest portion that is sent to the computing device 110F during the recording session. In some examples, once a cumulative size of the manifest portions send to the computing device 110F meets or exceeds a threshold size, the subsystem 103 may store the corresponding manifest portions as set (e.g., a “patch set”). The set of corresponding manifest portions that meet or exceed the threshold size may be stored in the storage medium 120D, which, as described herein, may comprise manifests for video on demand content and other “cold” manifest storage (e.g., manifests for content that is not being concurrently output and recorded).

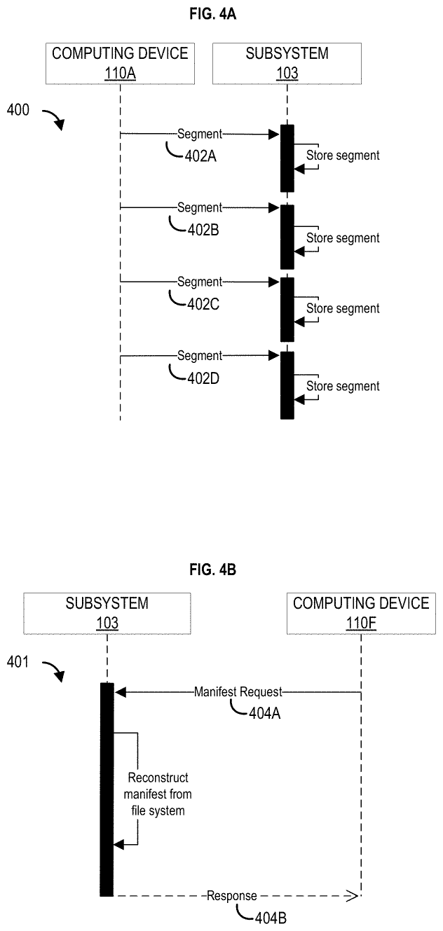

Turning now to FIGS. 4A and 4B, a workflow 400 and a workflow 401 are shown. As described herein, an initial manifest associated with content may be sent to the computing device 110F (e.g., such as when a recording session is begun). The phrase “initial manifest” as used herein refers to a first manifest for the content that the computing device 110F may request and/or a first instance in which the computing device 110F requests a manifest associated with the content. As shown in FIG. 4A, the subsystem 103 (e.g., any of the computing devices 110B-110D) may receive a plurality of segments 402A-402D from the computing device 110A as they are received and prepared for output/delivery (e.g., as they are transcoded based on the source stream 102). For example, the subsystem 103 may receive the plurality of segments 402A-402D of content from the computing device 110A. The subsystem 103 may store each segment of the plurality of segments 402A-402D that is received.

As shown in FIG. 4B, the computing device 110F may send a request 404A for a current manifest as described herein. While FIG. 4A shows the computing device 110F as the device that sends the request 404A, it is to be understood that any device in communication with the computing device 110F and the subsystem 103 may send the request 404A. The example shown in FIG. 4A and described herein (e.g., with the computing device 110F sending the request 404A) is meant to be exemplary and not limiting. The request 404A for the current manifest may comprise a request to update the initial manifest (e.g., thereby resulting in the current manifest).

Based on the request 404A, the subsystem 103 may determine whether a current/updated manifest associated with the content that is “newer” than an update threshold has already been generated (e.g., stored in a storage medium associated with the subsystem 103). For example, a manifest may meet or exceed the update threshold when a time the manifest was generated/published (e.g., based on a PublishTime element/identifier) plus a minimum update period (e.g., a quantity of time identified in an MPD@minimumUpdatePeriod element) is greater than a current time by a value N, The value N may be determined in advance (e.g., based on policy device requirements, network requirements, etc.). The subsystem 103 may respond to the request 404A by sending a manifest that meets or exceeds the update threshold.

In scenarios in which the subsystem 103 determines that no manifest associated with the content that has already been generated meets or exceeds the update threshold, the subsystem 103 may determine (e.g., generate) a current manifest associated with the content. For example, the subsystem 103 may determine (e.g., retrieve) all currently available segments associated with the content from the storage medium and corresponding content metadata stored in the storage medium 120F. The subsystem 103 may determine (e.g., generate) the current manifest by performing a reconstitution process using some, or all, of the currently available segments associated with the content. For example, the subsystem 103 may determine whether any of the currently available segments outside of the time-shift buffer described herein. The subsystem 103 may not use any of the currently available segments falling outside of the time-shift buffer when performing the reconstitution process. As part of the reconstituting process to determine the current manifest, the subsystem 103 may insert key identifiers into each segment of the currently available segments within the time-shift buffer. The key identifiers may comprise, for example, a plurality of manifest elements, such as an MPD identifier(s), a Period identifier(s), an Adaptation Set identifier(s), a Representation identifier(s), and/or an Initialization Segment identifier(s). At 404B, the subsystem 103 may send the current manifest to the computing device 110F.

As described herein, the subsystem 103 may send an initial manifest associated with content to the computing device 110F. As an example, the subsystem 103 may send the initial manifest to the computing device 110F via the computing device 110E (e.g., a just-in-time packager). As also described herein, the subsystem 103 may send a current manifest associated with the content (or a portion thereof) to the computing device 110F. The subsystem 103 may send the current manifest (or a portion thereof) to the computing device 110F via the computing device 110E. The initial manifest and the current manifest (or a portion thereof) may facilitate the computing device 110F accessing the corresponding segments of the content. For example, the computing device 110F may use the manifests (or portion(s)) to generate segment requests. The computing device 110E may receive the segment requests from the computing device 110F and serve (e.g., generate, retrieve, etc.) those segments to the computing device 110F. In some examples, the computing device 110E may maintain a data structure based on the initial manifest and the current manifest (or portion(s) thereof) in order to efficiently serve the requested segments to the computing device 110F.

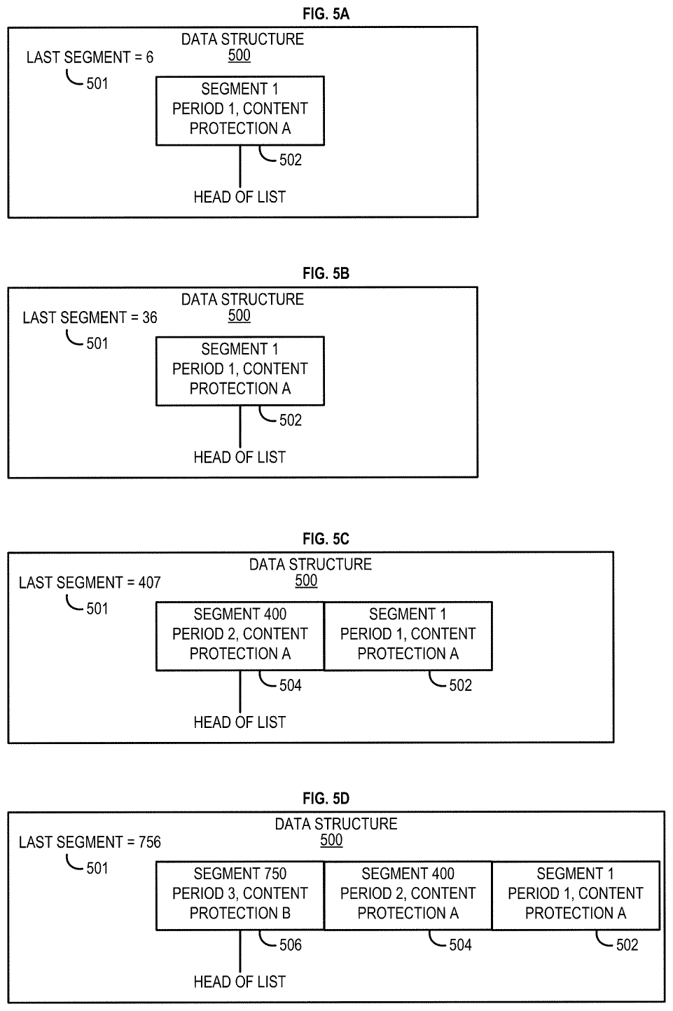

FIGS. 5A-5D show an example data structure 500 that may be maintained (e.g., created, updated, cached, etc.) by the computing device 110E based on the initial manifest and the current manifest (or portion(s) thereof). The data structure 500 may comprise a list, an array, a stack, a queue, a linked-list, etc. The computing device 110E may store the data structure 500 in the storage medium 120E or another storage medium (not shown) with which the computing device 110E may communicate. The data structure 500 may facilitate the computing device 110E determining all relevant Periods and/or Content Protection elements (e.g., Digital Rights Management elements) associated with the content. A “Period” or “period attribute” as used herein may correspond to a portion of a manifest and/or a plurality of manifest elements associated with a plurality of segments. A “Content Protection element” or a “content protection attribute” as used herein may correspond to an encryption key, an encryption element, a license key, or any other DRM element for content security. As content is prepared for delivery (e.g., encoded, transcoded, encrypted, etc.) a number of Periods and Content Protection elements may be identified in the initial manifest and the current manifest associated with the content. The data structure 500 may eliminate a need for the computing device 110E to cache the initial manifest and the current manifest (or portion(s) thereof), as the data structure 500 may indicate all relevant Periods and Content Protection elements associated with the content The data structure 500 may allow the computing device 110E to “look-up” the Period and Content Protection elements that correspond to a given segment number/identifier.

The phrase “initial manifest” as used herein refers to a first manifest for content that the computing device 110F may request and/or a first instance in which the computing device 110F requests a manifest associated with the content. When the computing device 110E sends/forwards an initial manifest associated with content to the computing device 110F, the computing device 110E may generate the data structure 500 as shown in FIG. 5A. For example, the computing device 110E may determine that a last segment number 501 associated with the initial manifest is segment number 6. The computing device 110E may add an entry 502 to the data structure 500 to indicate a first segment number in the initial manifest (Segment 1), a period attribute associated with the initial manifest (Period 1), and a content protection (e.g., DRM) attribute associated with the initial manifest (Content Protection A). The entry 502 may therefore indicate that Segments 1-6 are associated with Period 1 and Content Protection A.

The computing device 110F may request a first current manifest (or portion(s) thereof) associated with the content. The computing device 110E may cause the first current manifest to be determined/generated as described herein. The computing device 110E may update the last segment number 501 associated with the first current manifest as being segment number 36, as shown in FIG. 5B. The computing device 110E may determine that the period attribute (Period 1) and the content protection attribute (Content Protection A) associated with the first current manifest do not differ from the initial manifest, and as a result the computing device 110E may not added a new entry to the to the data structure 500. The entry 502 in conjunction with the last segment number 501 may therefore indicate that Segments 1-36 are associated with Period 1 and Content Protection A.

The computing device 110F may continue requesting further current manifests (or portion(s) thereof) associated with the content until the computing device 110E determines that the period attribute and the content protection attribute change. For example, the computing device 110F may request a second current manifest (or portion(s) thereof) associated with the content. The computing device 110E may cause the second current manifest to be determined/generated as described herein. The computing device 110E may update the last segment number 501 associated with the second current manifest as being segment number 407, as shown in FIG. 5C. The computing device 110E may determine that the period attribute associated with the second current manifest has changed to Period 2 and the content protection attribute associated with the second current manifest has remained the same (Content Protection A). As shown in FIG. 5C, the computing device 110E may add a new entry 504 to the to the data structure 500 to indicate the first segment in second manifest (Segment 400) as well as the period attribute and the content protection attribute for the second manifest. The entry 504 may therefore indicate that Segments 400-407 are associated with Period 2 and Content Protection A, and the entry 502 may indicate that Segments 1-399 are associated with Period 1 and Content Protection A.

The computing device 110F may request a third current manifest (or portion(s) thereof) associated with the content. The computing device 110E may cause the third current manifest to be determined/generated as described herein. The computing device 110E may update the last segment number 501 associated with the third current manifest as being segment number 756, as shown in FIG. 5D. The computing device 110E may determine that the period attribute associated with the third current manifest has changed to Period 3 and the content protection attribute associated with the third current manifest has changed to Content Protection B (e.g., reflecting an updated DRM key(s), etc.). As shown in FIG. 5D, the computing device 110E may add a new entry 506 to the to the data structure 500 to indicate the first segment in third manifest (Segment 750) as well as the period attribute and the content protection attribute for the third manifest. The entry 506 may therefore indicate that Segments 750-756 are associated with Period 3 and Content Protection B; the entry 504 may now indicate that Segments 400-749 are associated with Period 2 and Content Protection A; and the entry 502 may indicate that Segments 1-399 are associated with Period 1 and Content Protection A.

When the computing device 110F sends a request for a segment of the content to the computing device 110E, the computing device 110E may determine the corresponding period and content protection associated with the requested segment using the data structure 500 rather than relying upon a cached copy of the corresponding manifest (or portion thereof). For example, the computing device 110F may send a request for segment number 550 to the computing device 110E. The computing device 110E may determine, using the data structure 500, that the last segment number 501 indicates that a manifest, or a portion thereof, has been generated already for segment numbers 756 and earlier (e.g., Segment 1 through Segment 756). The computing device 110E may then determine, based on the entry 504, that the requested segment number (Segment 550) corresponds to Period 2 and Content Protection A, since it falls between Segments 400-749.

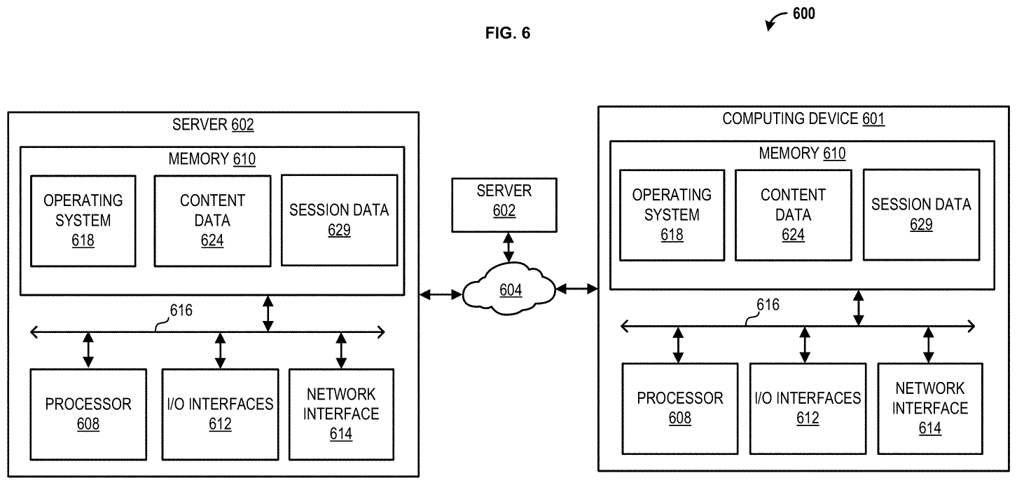

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the computing devices 110A-110F of the system 100 shown in FIG. 1. In an aspect, some or all steps of any described method may be performed on a computing device as described herein. The computing device 601 may comprise one or multiple computers configured to store one or more of session data 629 (e.g., a session index), and/or the like. For example, the session data 629 may comprise a storage medium, such as any of the storage media 120B-120E described herein. The server 602 may comprise one or multiple computers configured to store content data 624 (e.g., portions of a content item and related metadata). For example, the content data 624 may comprise a storage medium, such as any of the storage media 120B-120E described herein. Multiple servers 602 may communicate with the computing device 601 via the through the network 604.

The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. During operation of the computing device 601 and/or the server 602, the processor 608 may execute software stored within the system memory 610, to communicate data to and from the system memory 610, and to generally control operations of the computing device 601 and the server 602 pursuant to the software.

The I/O interfaces 612 may be used to receive user input from, and/or for sending system output to, one or more devices or components. User input may be received via, for example, a keyboard and/or a mouse. System output may be output via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media. Note that the system memory 610 may have a distributed architecture, where various components are situated remote from one another, but may be accessed by the processor 608.

The software in system memory 610 may include one or more software programs, each of which comprises an ordered listing of executable instructions for implementing logical functions. In the example of FIG. 6, the software in the system memory 610 of the computing device 601 may comprise the session data 629, the content data 624, and a suitable operating system (O/S) 618. In the example of FIG. 6, the software in the system memory 610 of the server 602 may comprise the session data 629, the content data 624, and a suitable operating system (O/S) 618. The operating system 618 essentially controls the execution of other computer programs and enables scheduling, input-output control, file and data management, memory management, and communication control and related services.

For purposes of illustration, application programs and other executable program components such as the operating system 618 are shown herein as discrete blocks, although it is recognized that such programs and components may reside at various times in different storage components of the computing device 601 and/or the server 602. An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

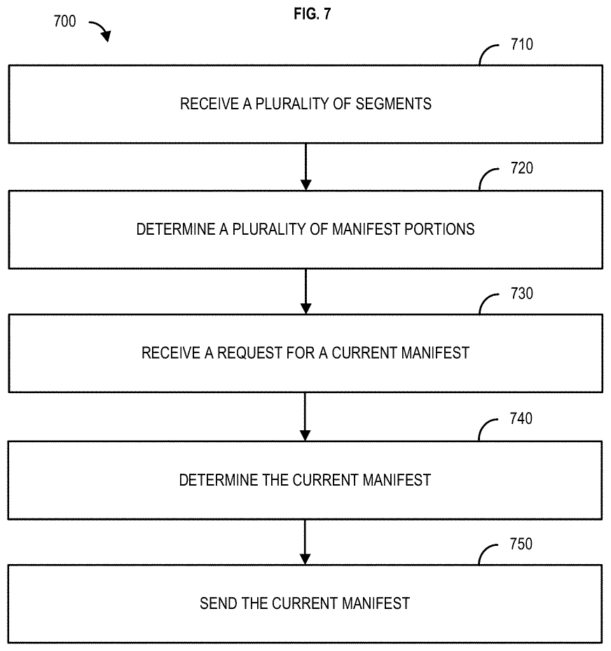

FIG. 7 shows a flowchart of an example method 700 for generating and updating manifests for content. The method 700 may be performed in whole or in part by a single computing device, a plurality of computing devices, and the like. For example, some or all steps of the method 700 may be performed by at least one of the computing devices 110A-110F shown in FIG. 1. For ease of explanation, the steps of the method 700 are described herein as being performed by a single computing device. However, it is to be understood that some steps of the method 700 may be performed by a first computing device, while other steps of the method 700 may be performed by another computing device(s).

At step 710, a first computing device may receive a plurality of segments of content. The first computing device may comprise any of the computing devices 110B-110D. The first computing device may receive the plurality of segments of the content from an upstream device, such as a transcoder, an encoder, or a packager.

At step 720, the first computing device may determine a plurality of manifest portions associated with the content. For example, the first computing device may determine the plurality of manifest portions based on the plurality of segments. Each manifest portion of the plurality of manifest portions may comprise at least one of: an indication of a presentation start time for the corresponding segment; a timestamp for the corresponding segment; a period identifier for the corresponding segment; a duration for the corresponding segment; or a segment identifier for the corresponding segment.

The first computing device may determine the plurality of manifest portions based on updates to the content. For example, the first computing device may receive in indication (e.g., via an out-of-band application programming interface) of an event update associated with the content, and the first computing device may determine the plurality of manifest portions based on the event update. The event update may comprise at least one of: an event scheduling notification interface update or an event scheduling and management update. An update to the content may comprise a digital rights management (DRM) update. For example, the first computing device may determine the plurality of manifest portions based on an indication of a DRM key rotation associated with the content (e.g., to update to the initial manifest with the new/updated DRM key(s)).

At step 730, the first computing device may receive a request for a current manifest associated with the content. For example, the first computing device may receive the request for the current manifest from a second computing device (e.g., the computing device 110F). The first computing device may determine an initial manifest associated with the content. The phrase “initial manifest” as used herein refers to a first manifest for the content that the second computing device may request and/or a first instance in which the second computing device requests a manifest associated with the content. For example, the first computing device may determine the initial manifest based on a first indication. The first indication may comprise, for example, an initialization of a stream associated with the content or a period associated with the content. The initial manifest may comprise a partial/skeleton manifest associated with the content. For example, the initial manifest may comprise information such as a Media Presentation Document associated with the content, a Period element(s), an AdaptationSet element(s), a Representation element(s), a SegmentTemplate element(s), and/or a ContentProtection element(s).

The first computing device may be configured to ignore the request for the current manifest (e.g., cause the request not to be processed) in certain scenarios. For example, the request may not be processed if it comprises or indicates an identifier for a segment of the content that falls outside of a time-shift buffer associated with the content. The request may comprise or indicate an identifier for a segment of the content that falls outside of the time-shift buffer associated with the content due to an error condition, such as a lack of synchronization between a clock of the first computing device and a clock of the second computing device. Additionally, the request may not be processed if it comprises or indicates a period of the content without any corresponding segments.

At step 740, the first computing device may determine the current manifest. For example, the first computing device may determine the current manifest based on the initial manifest associated with the content and the plurality of manifest portions. The first computing device may apply (e.g., patch) the initial manifest associated with the content using the plurality of manifest portions, thereby generating the current manifest. At step 750, the first computing device may send the current manifest to the second computing device. For example, the first computing device may send the current manifest to the second computing device based on the request. The current manifest may be configured to facilitate access to the plurality of segments of the content.

In some examples, prior to sending the current manifest to the second computing device, the first computing device may optimize the current manifest and corresponding metadata. For example, any segment identified in the current manifest that falls outside of the time-shift buffer may be removed from the current manifest and/or from storage. As another example, any segment identified in the current manifest associated with a presentation time that falls outside of the time-shift buffer associated with the content may be removed from the current manifest and/or from storage. As a further example, any segment identified in the current manifest associated with an event comprising an end time that falls outside of the time-shift buffer may be removed from the current manifest and/or from storage. The end time that falls outside of the time-shift buffer may be determined based on an event scheduling notification interface update or an event scheduling and management update as described herein.

As another example, the first computing device may optimize the current manifest by determining, for each two consecutive segment elements (e.g, SegmentTimeline.S elements) identified in the current manifest, whether their respective duration values (e.g., S@d values) match. In such a case, a value for the first segment element of the two consecutive segment elements (e.g., the S@r value of the first element) may be incremented in the current manifest, and the second segment element of the two consecutive segment elements may be removed from the current manifest. This example optimization process may be iterative. For example, the first computing device may repeat this process for every two segment elements (e.g., consecutive segment elements) until the respective duration elements (S@d values) do not match (e.g., until one of the two particular segment elements being evaluated has a different S@d value compared to the other segment element). As another example, the first computing device may optimize the current manifest by associating one or more segment elements (e.g., SegmentTimeline elements) in the current manifest with another manifest element of the plurality of manifest elements, such as a manifest element corresponding to an AdaptationSet level of the current manifest. As a further example, the first computing device may optimize the current manifest by identifying segment gaps in each representation of the content identified in the current manifest (e.g., missing segments) and associating such gaps with a further manifest element (e.g., a FailoverContent element(s)). The optimized current manifest may be stored in a storage medium (e.g., the storage medium 120C).

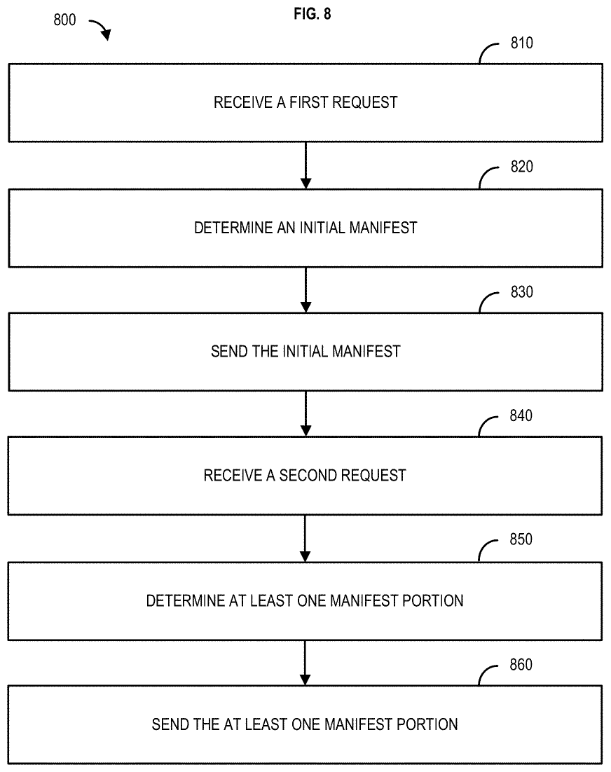

FIG. 8 shows a flowchart of an example method 800 for generating and updating manifests for content. The method 800 may be performed in whole or in part by a single computing device, a plurality of computing devices, and the like. For example, some or all steps of the method 800 may be performed by at least one of the computing devices 110A-110F shown in FIG. 1. For ease of explanation, the steps of the method 800 are described herein as being performed by a single computing device. However, it is to be understood that some steps of the method 800 may be performed by a first computing device, while other steps of the method 800 may be performed by another computing device(s).

At step 810, a first computing device may receive a first request for an initial manifest associated with content. The first computing device may comprise any of the computing devices 110B-110D. The first request may be associated with a recording session. The recording session may be associated with a second computing device (e.g., the computing device 110F) concurrently outputting and recording the content. The phrase “initial manifest” as used herein refers to a first manifest for the content that the second computing device may request and/or a first instance in which the second computing device requests a manifest associated with the content.

At step 820, the first computing device may determine the initial manifest and a manifest index associated with the recording session. For example, the first computing device may determine the initial manifest and the manifest index based on the request for the initial manifest. The manifest index may comprise metadata for the recording session and a time the initial manifest was published/generated (e.g., a PublishTime element/identifier) as well as a time(s) additional portions of the manifest associated with the content that are used to update the initial manifest were generated (e.g., a PublishTime element/identifier for each portion). At step 830, the first computing device may send the initial manifest. For example, the first computing device may send the initial manifest to the second computing device. The initial manifest may be configured to facilitate access to a first plurality of segments of the content.

At step 840, first computing device may receive a second request. The second request may comprise a request for at least one manifest portion of a plurality of manifest portions associated with the content. The second request may be associated with the recording session. The plurality of manifest portions may correspond to new/additional segments of the content. Each manifest portion of the plurality of manifest portions may comprise at least one of: an indication of a presentation start time for the corresponding segment; a timestamp for the corresponding segment; a period identifier for the corresponding segment; a duration for the corresponding segment; or a segment identifier for the corresponding segment. The plurality of manifest portions may be identified in the manifest index. For example, the plurality of manifest portions may be associated with a second plurality of segments of the content (e.g., new/additional segments). The first computing device may retrieve corresponding segment metadata, such as a Presentation Time Stamp (PTS), Period, and/or other metadata associated with the second plurality of segments (e.g., from the storage medium 120F).

At step 850, the first computing device may determine the at least one manifest portion based on the second request, the manifest index, and the corresponding segment metadata. For example, the initial manifest may comprise a first timestamp indicative of a time that the initial manifest was generated/published (e.g., a PublishTime element/identifier). The second request may comprise an indication of a request for an additional/current manifest portion associated with a time that is greater than the first timestamp (referred to herein as a “request time”). Based on the request time, the first computing device may determine/retrieve the metadata associated with the second plurality of segments (e.g., from the storage medium 120F). The first computing device may determine (e.g., generate or identify) the at least one manifest portion based on the request time and the metadata associated with the second plurality of segments (e.g., to determine which segment(s) were or were not included in the initial manifest).

At step 860, the first computing device may send the at least one manifest portion to the second computing device. The at least one manifest portion may be configured to facilitate access to at least one segment of the second plurality of segments of the content. For example, the second computing device may use the at least one manifest portion to update the initial manifest, thereby generating a current manifest as described herein.

The first computing device may store an indication of the at least one manifest portion in the manifest index (e.g., to indicate the second computing device has received the at least one manifest portion). The second computing device may request further manifest portions during the recording session. The first computing device may store an indication in the manifest index of each further manifest portion that is sent to the second computing device during the recording session. In some examples, once a cumulative size of the manifest portions sent to the second computing device meets or exceeds a threshold size, the first computing device may store the corresponding manifest portions as a set (e.g., a “patch set”). The set of corresponding manifest portions that meet or exceed the threshold size may be stored (e.g., in the storage medium 120D) in a storage medium comprising manifests for video on demand content and other “cold” manifest storage (e.g., manifests for content that is not being concurrently output and recorded).

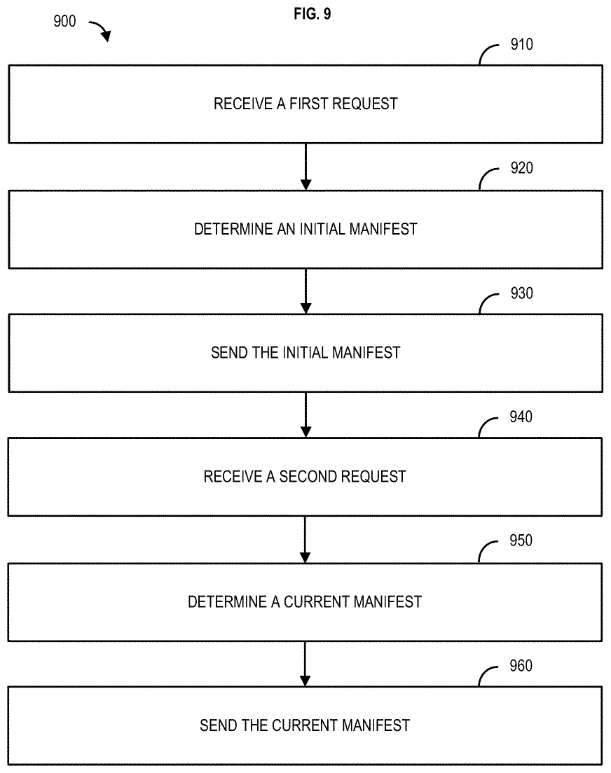

FIG. 9 shows a flowchart of an example method 900 for generating and updating manifests for content. The method 900 may be performed in whole or in part by a single computing device, a plurality of computing devices, and the like. For example, some or all steps of the method 900 may be performed by at least one of the computing devices 110A-110F shown in FIG. 1. For ease of explanation, the steps of the method 900 are described herein as being performed by a single computing device. However, it is to be understood that some steps of the method 900 may be performed by a first computing device, while other steps of the method 900 may be performed by another computing device(s).

At step 910, a first computing device may receive a first request for an initial manifest associated with content. The first computing device may comprise any of the computing devices 110B-110D. The first request may be associated with a recording session. The recording session may be associated with a second computing device (e.g., the computing device 110F) concurrently outputting and recording the content. The phrase “initial manifest” as used herein refers to a first manifest for the content that the second computing device may request and/or a first instance in which the second computing device requests a manifest associated with the content.

At step 920, the first computing device may determine the initial manifest and a manifest index associated with the recording session. For example, the first computing device may determine the initial manifest and the manifest index based on the request for the initial manifest. The manifest index may comprise metadata for the recording session and a time the initial manifest was published/generated (e.g., a PublishTime element/identifier) as well as a time(s) additional portions of the manifest associated with the content that are used to update the initial manifest were generated (e.g., a PublishTime element/identifier for each portion). The metadata for the recording session may also indicate/identify additional portions of the manifest associated with the content that are used to update the initial manifest, including a publish/generation time for each portion. The computing device may determine the initial manifest and the manifest index based on a session index identifying the recording session. The session index may comprise recording session metadata, such as recording session identifiers associated with a plurality of recording sessions (e.g., devices recording content), device identifiers, content identifiers, and/or the content metadata described herein.

At step 930, the first computing device may send the initial manifest. For example, the first computing device may send the initial manifest to the second computing device. The initial manifest may be configured to facilitate access to a first plurality of segments of the content. At step 940, the first computing device may receive a second request. The first computing device may receive the second request from the second computing device. The second request may be associated with the recording session. The second request may comprise a request for a current manifest associated with the content.

The initial manifest may comprise a first timestamp indicative of a time that the initial manifest was generated/published (e.g., a PublishTime element/identifier). The second request may indicate the current manifest is associated with a time that is greater than the first timestamp (referred to herein as a “request time”). Based on the request time, the first computing device may determine/retrieve the metadata associated with a second plurality of segments (e.g., from the storage medium 120F). For example, the first computing device may retrieve corresponding segment metadata for the second plurality of segments, such as a Presentation Time Stamp (PTS), Period, and/or other metadata associated with the second plurality of segments (e.g., from the storage medium 120F).

The first computing device may determine (e.g., generate or identify) a plurality of manifest portions based on the request time and the metadata associated with the second plurality of segments (e.g., to determine which segment(s) were or were not included in the initial manifest). Each manifest portion of the plurality of manifest portions may comprise at least one of: an indication of a presentation start time for the corresponding segment; a timestamp for the corresponding segment; a period identifier for the corresponding segment; a duration for the corresponding segment; or a segment identifier for the corresponding segment. The plurality of manifest portions may be stored in the manifest index. For example, the plurality of manifest portions may be associated with a second plurality of segments of the content (e.g., new/additional segments). The first computing device may store an indication of the plurality of manifest portions in the manifest index.

At step 950, the first computing device may determine the current manifest. For example, the first computing device may apply (e.g., patch) the initial manifest associated with the content using the plurality of manifest portions as described herein, thereby generating the current manifest. current manifest. At step 960, the first computing device may send the current manifest to the second computing device. The current manifest may be configured to facilitate access to at least one segment of the second plurality of segments of the content. In some examples, a size of the plurality of manifest portions may meet or exceed a threshold size. In such examples, the first computing device may store the corresponding manifest portions as a set (e.g., a “patch set”). The set of corresponding manifest portions that meet or exceed the threshold size may be stored (e.g., in the storage medium 120D) in a storage medium comprising manifests for video on demand content and other “cold” manifest storage (e.g., manifests for content that is not being concurrently output and recorded).

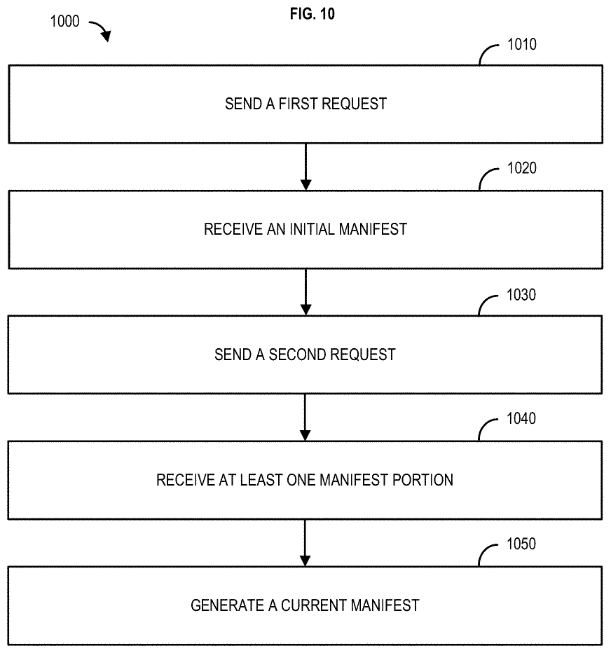

FIG. 10 shows a flowchart of an example method 1000 for generating and updating manifests for content. The method 1000 may be performed in whole or in part by a single computing device, a plurality of computing devices, and the like. For example, some or all steps of the method 1000 may be performed by at least one of the computing devices 110A-110F shown in FIG. 1. For ease of explanation, the steps of the method 1000 are described herein as being performed by a single computing device. However, it is to be understood that some steps of the method 1000 may be performed by a first computing device, while other steps of the method 1000 may be performed by another computing device(s).

At step 1010, a first computing device may send a first request for an initial manifest associated with content. The first computing device may comprise a client device, a user device, a media device, and/or any other computing devices for outputting content (e.g., the computing device 110F). The first request may be associated with a recording session. The recording session may be associated with the first computing device concurrently outputting and recording the content. The phrase “initial manifest” as used herein refers to a first manifest for the content that the first computing device may request and/or a first instance in which the first computing device requests a manifest associated with the content.

A second computing device may determine the initial manifest and a manifest index associated with the recording session. The second computing device may comprise any of the computing devices 110B-110D. The second computing device may determine the initial manifest and the manifest index based on the request for the initial manifest. The manifest index may comprise metadata for the recording session and a time the initial manifest was published/generated (e.g., a PublishTime element/identifier) as well as a time(s) additional portions of the manifest associated with the content that are used to update the initial manifest were generated (e.g., a PublishTime element/identifier for each portion). The second computing device, or another computing device in communication with the second computing device (e.g., any of the computing devices 110B-110D), may send the initial manifest to the first computing device.

At step 1020, the first computing device may receive the initial manifest (e.g., from/via the second computing device). The initial manifest may be configured to facilitate access to a first plurality of segments of the content. For example, the first computing device may use the initial manifest to generate at least one request for at least one segment of the first plurality of segments of the content. The first computing device may send the at least one request for the at least one segment to an upstream computing device (e.g., the computing device 110E). The upstream computing device may receive the at least one request for the at least one segment. The upstream computing device, or another computing device in communication with the upstream computing device (e.g., any of the computing devices 110B-110D), may send the at least one segment to the first computing device.

At step 1030, the first computing device may send a second request. The second request may comprise a request for at least one manifest portion of a plurality of manifest portions associated with the content. The second request may be associated with the recording session. The plurality of manifest portions may correspond to new/additional segments of the content. Each manifest portion of the plurality of manifest portions may comprise at least one of: an indication of a presentation start time for the corresponding segment; a timestamp for the corresponding segment; a period identifier for the corresponding segment; a duration for the corresponding segment; or a segment identifier for the corresponding segment. The plurality of manifest portions may be identified in the manifest index. For example, the plurality of manifest portions may be associated with a second plurality of segments of the content (e.g., new/additional segments). The second computing device may retrieve corresponding segment metadata, such as a Presentation Time Stamp (PTS), Period, and/or other metadata associated with the second plurality of segments (e.g., from the storage medium 120F).

The second computing device may determine the at least one manifest portion. The second computing device may determine the at least one manifest portion based on the second request, the manifest index, and the corresponding segment metadata. For example, the initial manifest may comprise a first timestamp indicative of a time that the initial manifest was generated/published (e.g., a PublishTime element/identifier). The second request may comprise an indication of a request for an additional/current manifest portion associated with a time that is greater than the first timestamp (referred to herein as a “request time”). Based on the request time, the second computing device may determine/retrieve the metadata associated with the second plurality of segments (e.g., from the storage medium 120F). The second computing device may determine (e.g., generate or identify) the at least one manifest portion. The second computing device may determine the at least one manifest portion based on the request time and the metadata associated with the second plurality of segments (e.g., to determine which segment(s) were or were not included in the initial manifest).

At step 1040, the first computing device may receive the at least one manifest portion. The first computing device may receive the at least one manifest portion from the second computing device or another computing device in communication with the second computing device. The at least one manifest portion may be configured to update the initial manifest and to facilitate access to the second plurality of segments of the content. At step 1050, the first computing device may generate a current manifest. For example, the first computing device may use the at least one manifest portion to update the initial manifest, thereby generating the current manifest as described herein.

The first computing device may use the current manifest to generate at least one further request. The at least one further request may comprise a request for at least one segment of the second plurality of segments of the content. The first computing device may send the at least one further request to the upstream computing device. The upstream computing device may receive the at least one further request. The upstream computing device, or another computing device in communication with the upstream computing device (e.g., any of the computing devices 110B-110D), may send the at least one further segment to the first computing device. In some examples, the upstream computing device may maintain a data structure (e.g., the data structure 500) based on the initial manifest and the current manifest (or portion(s) thereof) in order to efficiently serve the requested segments to the first computing device, as described herein.

The second computing device may store an indication of the at least one manifest portion in the manifest index (e.g., to indicate the first computing device has received the at least one manifest portion). The first computing device may request further manifest portions during the recording session. The second computing device may store an indication in the manifest index of each further manifest portion that is sent to the first computing device during the recording session. In some examples, once a cumulative size of the manifest portions sent to the first computing device meets or exceeds a threshold size, the second computing device may store the corresponding manifest portions as a set (e.g., a “patch set”). The set of corresponding manifest portions that meet or exceed the threshold size may be stored (e.g., in the storage medium 120D). For example, the set of corresponding manifest portions may be stored in a storage medium comprising manifests for video on demand content and other “cold” manifest storage (e.g., manifests for content that is not being concurrently output and recorded).

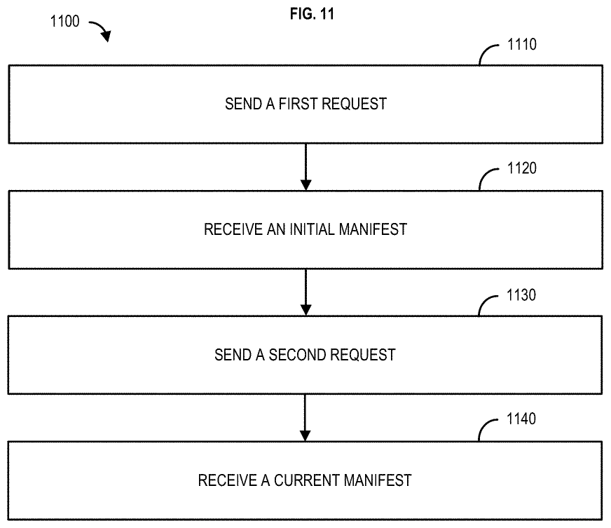

FIG. 11 shows a flowchart of an example method 1100 for generating and updating manifests for content. The method 1100 may be performed in whole or in part by a single computing device, a plurality of computing devices, and the like. For example, some or all steps of the method 1100 may be performed by at least one of the computing devices 110A-110F shown in FIG. 1. For ease of explanation, the steps of the method 1100 are described herein as being performed by a single computing device. However, it is to be understood that some steps of the method 1100 may be performed by a first computing device, while other steps of the method 1100 may be performed by another computing device(s).

At step 1110, a first computing device may send a first request for an initial manifest associated with content. The first computing device may comprise a client device, a user device, a media device, and/or any other computing devices for outputting content (e.g., the computing device 110F). The first request may be associated with a recording session. The recording session may be associated with the first computing device concurrently outputting and recording the content. The phrase “initial manifest” as used herein refers to a first manifest for the content that the first computing device may request and/or a first instance in which the first computing device requests a manifest associated with the content.

A second computing device may determine the initial manifest and a manifest index associated with the recording session. The second computing device may comprise any of the computing devices 110B-110D. The second computing device may determine the initial manifest and the manifest index based on the request for the initial manifest. The manifest index may comprise metadata for the recording session and a time the initial manifest was published/generated (e.g., a PublishTime element/identifier). The manifest index may comprise a time(s) additional portions of the manifest associated with the content that are used to update the initial manifest were generated (e.g., a PublishTime element/identifier for each portion). The second computing device, or another computing device in communication with the second computing device (e.g., any of the computing devices 110B-110D), may send the initial manifest to the first computing device.

At step 1120, the first computing device may receive the initial manifest (e.g., from/via the second computing device). The initial manifest may be configured to facilitate access to a first plurality of segments of the content. For example, the first computing device may use the initial manifest to generate at least one request for at least one segment of the first plurality of segments of the content. The first computing device may send the at least one request for the at least one segment to an upstream computing device (e.g., the computing device 110E). The upstream computing device may receive the at least one request for the at least one segment. The upstream computing device, or another computing device in communication with the upstream computing device (e.g., any of the computing devices 110B-110D), may send the at least one segment to the first computing device.

The second computing device may determine (e.g., generate or identify) a plurality of manifest portions associated with a second plurality of segments of the content (e.g., new/additional segments). Each manifest portion of the plurality of manifest portions may comprise at least one of: an indication of a presentation start time for the corresponding segment; a timestamp for the corresponding segment; a period identifier for the corresponding segment; a duration for the corresponding segment; or a segment identifier for the corresponding segment.

The plurality of manifest portions may be stored in the manifest index. For example, the plurality of manifest portions may be associated with a second plurality of segments of the content. The second computing device may store an indication of the plurality of manifest portions in the manifest index. In some examples, a size of the plurality of manifest portions may meet or exceed a threshold size. In such examples, the second computing device may store the corresponding manifest portions as a set (e.g., a “patch set”). The set of corresponding manifest portions that meet or exceed the threshold size may be stored (e.g., in the storage medium 120D) in a storage medium comprising manifests for video on demand content and other “cold” manifest storage (e.g., manifests for content that is not being concurrently output and recorded).

At step 1130, the first computing device may send a second request. The second request may be associated with the recording session. The second request may comprise a request for a current manifest for the content. The second computing device may determine/generate the current manifest for the content. The second computing device may determine/generate the current manifest based on the second request. Alternatively, the second computing device may have previously determined/generated the current manifest prior to the first computing device sending the second request. The second computing device may apply (e.g., patch) the initial manifest associated with the content using the plurality of manifest portions as described herein, thereby generating the current manifest. The second computing device, or another computing device in communication therewith, may send the current manifest to the first computing device.

At step 1140, the first computing device may receive the current manifest. The current manifest may be configured to facilitate access to at least one segment of the second plurality of segments of the content. The first computing device may use the current manifest to generate at least one further request. The at least one further request may comprise a request for the at least one segment of the second plurality of segments of the content. The first computing device may send the at least one further request to the upstream computing device. The upstream computing device may receive the at least one further request. The upstream computing device, or another computing device in communication with the upstream computing device (e.g., any of the computing devices 110B-110D), may send the at least one further segment to the first computing device. In some examples, the upstream computing device may maintain a data structure (e.g., the data structure 500) based on the initial manifest and the current manifest (or portion(s) thereof) in order to efficiently serve the requested segments to the first computing device, as described herein.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a first computing device, a plurality of segments of content;
determining, based on the plurality of segments, a plurality of manifest portions associated with the content;
receiving, from a second computing device, a request for a current manifest associated with the content;
determining, based on an initial manifest associated with the content and the plurality of manifest portions, the current manifest; and
sending, based on the request, the current manifest to the second computing device, wherein the current manifest is configured to facilitate access to the plurality of segments of the content.

2. The method of claim 1, wherein receiving the plurality of segments comprises:
receiving, from an upstream device, the plurality of segments, wherein the upstream device comprises at least one of: a transcoder, an encoder, or a packager.

3. The method of claim 1, wherein each manifest portion of the plurality of manifest portions comprises at least one of:
an indication of a presentation start time for at least one segment of the plurality of segments;
a timestamp for at least one segment of the plurality of segments;
a period identifier for at least one segment of the plurality of segments;
a duration for at least one segment of the plurality of segments; or
a segment identifier for at least one segment of the plurality of segments.

4. The method of claim 1, further comprising:
determining, based on a first indication, the initial manifest associated with the content, wherein the first indication comprises: an initialization of a stream associated with the content or a period associated with the content.

5. The method of claim 1, wherein the initial manifest comprises a partial manifest associated with the content.

6. The method of claim 1, wherein determining the plurality of manifest portions associated with the content comprises at least one of:
determining, based on an event update associated with the content, a first manifest portion of the plurality of manifest portions, wherein the event update comprises at least one of: an event scheduling notification interface update or an event scheduling and management update; or
determining, based on an indication of a digital rights management key rotation associated with the content, a second portion of the plurality of manifest portions.

7. The method of claim 1, further comprising at least one of:
determining, based on the current manifest comprising an identifier for a segment of the content that falls outside of a time-shift buffer associated with the content, that the request is not to be processed;
causing the segment that falls outside of the time-shift buffer to be removed from a storage medium;
determining, based on the request for the current manifest identifying a period of the content without any corresponding segments, that the request is not to be processed; or
determining, based on metadata associated with at least one segment of the plurality of segments, that the at least one segment is to be removed from a storage medium, wherein the metadata indicates at least one of:
the at least one segment being associated with a presentation time that falls outside of a time-shift buffer associated with the content; or
the at least one segment being associated with an event comprising an end time that falls outside of the time-shift buffer.

8. A method comprising:
receiving, by a first computing device, a first request for an initial manifest associated with content, wherein the first request is associated with a recording session, and wherein the recording session is associated with a second computing device concurrently outputting and recording the content;
sending, to the second computing device, the initial manifest, wherein the initial manifest is configured to facilitate access to a first plurality of segments of the content;
receiving a second request associated with at least one manifest portion of a plurality of manifest portions associated with the content, wherein the second request is associated with the recording session;
determining, based on the second request, the at least one manifest portion, wherein the plurality of manifest portions are associated with a second plurality of segments of the content; and
sending, to the second computing device, the at least one manifest portion, wherein the at least one manifest portion is configured to facilitate access to at least one segment of the second plurality of segments of the content.

9. The method of claim 8, further comprising:
determining, based on the recording session, a session index, wherein the session index is indicative of one or more of: an identifier for the recording session, first metadata associated with the first plurality of segments, or second metadata associated with the second plurality of segments; and
determining, based on the request for the initial manifest, and based on the session index, a manifest index associated with the recording session, wherein the plurality of manifest portions are identified in the manifest index.

10. The method of claim 8, further comprising:
receiving the second plurality of segments;
determining, based on the second plurality of segments, the plurality of manifest portions; and
storing, in the manifest index, an indication of the plurality of manifest portions.

11. The method of claim 8, wherein each manifest portion of the plurality of manifest portions comprises at least one of:
an indication of a presentation start time for at least one segment of the second plurality of segments;
a timestamp for at least one segment of the second plurality of segments;
a period identifier for at least one segment of the second plurality of segments;
a duration for at least one segment of the second plurality of segments; or
a segment identifier for at least one segment of the second plurality of segments.

12. The method of claim 8, wherein the initial manifest comprises a first timestamp indicative of a time that the initial manifest was generated, and wherein the second request comprises an indication of a request for a current manifest portion associated with a time that is greater than the first timestamp.

13. The method of claim 8, wherein determining the at least one manifest portion comprises:
determining, based on the request for the current manifest portion associated with the time that is greater than the first timestamp, metadata associated with the second plurality of segments;
determining, based on the time that is greater than the first timestamp and the metadata associated with the second plurality of segments, the at least one manifest portion; and
storing, in the manifest index, an indication of the at least one manifest portion.

14. The method of claim 8, further comprising
determining that the plurality of manifest portions satisfy a size threshold;
storing the plurality of manifest portions in a storage medium configured to facilitate access to the content for computing devices that are not concurrently recording and outputting the content; and
causing the plurality of manifest portions to be removed from a memory of the first computing device.

15. A method comprising:
receiving, by a first computing device, a first request for a manifest for content, wherein the first request is associated with a recording session, and wherein the recording session is associated with a second computing device concurrently outputting and recording the content;
determining, based on the first request, and based on a session index associated with the recording session, an initial manifest and a manifest index associated with the recording session;
sending, to the second computing device, the initial manifest, wherein the initial manifest is configured to facilitate access to a first plurality of segments of the content;
receiving a second request for a current manifest associated with the content, wherein the second request is associated with the recording session;
determining, based on the initial manifest and a plurality of manifest portions identified in the manifest index, the current manifest; and
sending, to the second computing device, the current manifest, wherein the current manifest is configured to facilitate access to a second plurality of segments of the content.

16. The method of claim 15, further comprising:
determining, based on the recording session, the session index, wherein the session index is indicative of one or more of: an identifier for the recording session, first metadata associated with the first plurality of segments, or second metadata associated with the second plurality of segments.

17. The method of claim 15, further comprising:
receiving the second plurality of segments;
determining, based on the second plurality of segments, the plurality of manifest portions; and
storing, in the manifest index, an indication of the plurality of manifest portions.

18. The method of claim 15, wherein each manifest portion of the plurality of manifest portions comprises at least one of:
an indication of a presentation start time for at least one segment of the second plurality of segments;
a timestamp for at least one segment of the second plurality of segments;
a period identifier for at least one segment of the second plurality of segments;
a duration for at least one segment of the second plurality of segments; or
a segment identifier for at least one segment of the second plurality of segments.

19. The method of claim 15, wherein the initial manifest comprises a first timestamp indicative of a time that the initial manifest was generated, and wherein the second request is indicative of a time that is greater than the first timestamp, and wherein determining the current manifest comprises:
determining, based on the second request being indicative of the time that is greater than the first timestamp, metadata associated with the second plurality of segments; and
determining, based on the initial manifest and the metadata associated with the second plurality of segments, the current manifest.

20. The method of claim 15, further comprising:
determining that the plurality of manifest portions satisfy a size threshold; and
storing the plurality of manifest portions in a storage medium configured to facilitate access to the content for computing devices that are not concurrently recording and outputting the content.
